(19) United States
(12) Patent Application Publication
(10) Pub. No.: US 2016/0162469 A1
(43) Pub. Date: Jun. 9, 2016

(54) Dynamic Local ASR Vocabulary

(71) Applicant: Audience, Inc., Mountain View, CA (US)

(72) Inventor: Peter Santos, Palo Alto, CA (US)

(21) Appl. No.: 14/962,931

(22) Filed: Dec. 8, 2015

Related U.S. Application Data
(60) Provisional application No. 62/089,716, filed on Dec. 9, 2014.

(51) Int. Cl. G06F 17/27; G10L 15/30; G10L 15/20; G10L 15/22

(52) U.S. Cl. CPC G06F 17/2735; G10L 15/22; G10L 15/30; G10L 15/20

(57) ABSTRACT

Systems and methods for a dynamic local automatic speech recognition (ASR) vocabulary are provided. An example method includes defining a user actionable screen content based on user interactions. At least a portion of the user actionable screen content is labeled. A local vocabulary associated with a local ASR engine is created based partially on the labeling. The local vocabulary includes words associated with functions of a mobile device and is limited by resources of the mobile device. The method includes determining whether speech includes a local key phrase or a cloud-based key phrase. Based on the determination, the method includes performing ASR on the speech using the local ASR engine or forwarding the speech to a cloud-based computing engine and performing ASR therewithin based on the cloud-based computing engine's larger vocabulary.

### CROSS-REFERENCE TO RELATED APPLICATIONS

The present application claims the benefit of U.S. Provisional Application No. 62/089,716, filed Dec. 9, 2014. The present application is related to U.S. patent application Ser. No. 14/522,264, filed Oct. 23, 2014. The subject matter of the aforementioned applications is incorporated herein by reference for all purposes.

### FIELD

The present application relates generally to speech processing and, more specifically, to automatic speech recognition.

### BACKGROUND

Systems and methods for automatic speech recognition (ASR) are widely used in various applications on mobile devices, for example, in voice user interfaces. Performance of ASR on a mobile device can be limited due to limitations of a mobile device's computing resources, which may, for example, lead to a shortage of a vocabulary for ASR.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Methods and systems for providing a dynamic local ASR vocabulary are provided. An example method allows defining a user actionable screen content associated with a mobile device. The method includes labeling at least a portion of the user actionable screen content. The method includes creating, based on the labeling, a first vocabulary. The first vocabulary is associated with a first ASR engine.

In some embodiments, the user actionable screen content is based partially on the user interaction with the mobile device. In certain embodiments, the first ASR engine is associated with the mobile device.

In some embodiments, the first vocabulary includes words associated with at least one function of the mobile device. In certain embodiments, a size of the first vocabulary is limited by resources of the mobile device.

In some embodiments, the method further includes detecting at least one key phrase in speech, the speech including at least one captured sound. The method allows determining whether the key phrase is a local key phrase or a cloud-based key phrase. If the key phrase is a local key phrase, ASR on the speech is performed with the first ASR engine. If the key phrase is a cloud-based key phrase, then the speech and/or the key phrase are forwarded to at least one cloud-based computing resource (a cloud). ASR is performed on the speech with a second ASR engine. The second ASR engine is associated with a second vocabulary and the cloud.

In some embodiments, the method allows performing at least noise suppression and/or noise reduction on the speech before performing the ASR on the speech by the first ASR engine to improve robustness of the ASR.

In some embodiments, the first vocabulary is smaller than the second vocabulary. In certain embodiments, the first vocabulary includes from 1 to 100 words, and the second vocabulary includes more than 100 words.

In some embodiments, the determination as to whether the at least one key phrase is a local key phrase or a cloud-based key phrase is based, at least partially, on a profile. The profile may be associated with the mobile device and/or the user. In certain embodiments, the profile includes commands that can be executed locally on the mobile device, commands that can be executed remotely in the cloud, and commands that can be executed both locally on the mobile device and remotely in the cloud. In some embodiments, the profile includes at least one rule. The rule may include forwarding the speech to the cloud to perform the ASR on the speech by the second ASR engine if a score of performing the ASR on the speech by the first ASR engine is less than a pre-determined value.

According to yet another example embodiment of the present disclosure, the steps of the method for providing dynamic local ASR vocabulary are stored on a non-transitory machine-readable medium comprising instructions, which, when implemented by one or more processors, perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is block diagram illustrating a system in which methods and systems for providing a dynamic local ASR vocabulary can be practiced, according to various example embodiments.

FIG. 2 is a block diagram of an example mobile device, in which a method for providing a dynamic local ASR vocabulary can be practiced.

FIG. 3 is a block diagram showing a system for providing a dynamic local ASR vocabulary and hierarchical assignment of recognition tasks, according to various example embodiments.

FIG. 4 is a flow chart illustrating steps of a method for providing a dynamic local ASR vocabulary.

FIG. 5 is a flow chart illustrating steps of a method for hierarchical assignment of recognition tasks, according to various example embodiments.

FIG. 6 is a flow chart illustrating steps of a method for selecting performance of speech recognition based on a profile, according to various example embodiments.

FIG. 7 is an example computer system that may be used to implement embodiments of the disclosed technology.

### DETAILED DESCRIPTION

The present disclosure is directed to systems and methods for providing a dynamic local automatic speech recognition (ASR) vocabulary. Various embodiments of the present technology can be practiced with mobile devices configured to capture audio signals and may provide for improvement of automatic speech recognition in the captured audio. The mobile devices may include: radio frequency (RF) receivers, transmitters, and transceivers; wired and/or wireless telecommunications and/or networking devices; amplifiers; audio and/or video players; encoders; decoders; speakers; inputs; outputs; storage devices; user input devices; and the like. Mobile devices can include input devices such as buttons, switches, keys, keyboards, trackballs, sliders, touch screens, one or more microphones, gyroscopes, accelerometers, global positioning system (GPS) receivers, and the like. Mobile devices can include outputs, such as LED indicators, video displays, touchscreens, speakers, and the like. In various embodiments, mobile devices are hand-held devices, such as notebook computers, tablet computers, phablets, smart phones, personal digital assistants, media players, mobile telephones, video cameras, and the like.

In various embodiments, the mobile devices are used in stationary and portable environments. The stationary environments include residential and commercial buildings or structures, and the like. For example, the stationary environments can include living rooms, bedrooms, home theaters, conference rooms, auditoriums, business premises, and the like. The portable environments can include moving vehicles, moving persons, other transportation means, and the like.

According to an example embodiment, a method for providing a dynamic local ASR vocabulary includes defining a user actionable screen content associated with a mobile device. The user actionable screen content may be based on the user interaction with the mobile device. The method can include labeling at least a portion of the user actionable screen content. The method may also include creating, based on the labeling, a local vocabulary. The local vocabulary can correspond to a local ASR engine associated with the mobile device. Various embodiments of the method can include performing noise suppression and noise reduction on speech prior to performing the ASR on the speech by the first ASR engine to improve robustness of the ASR. The speech may include at least one captured sound.

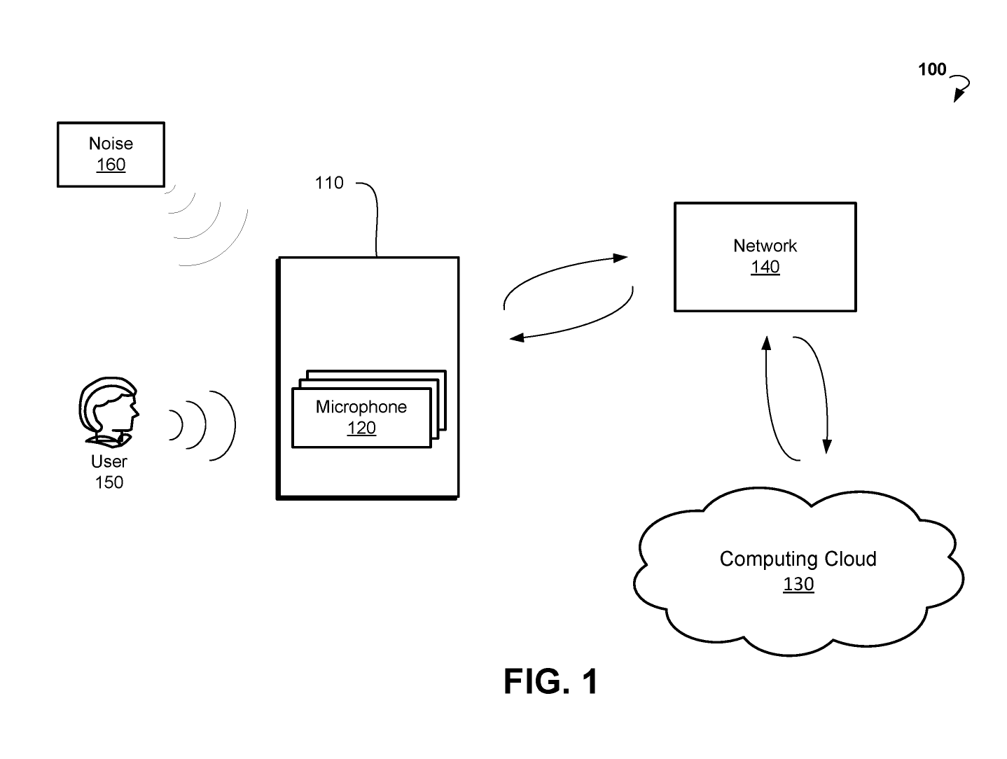

Referring now to FIG. 1, an example system 100 is shown. The system 100 can include a mobile device 110 and one or more cloud-based computing resources 130, also referred to herein as a computing cloud(s) 130 or a cloud 130. The cloud-based computing resource(s) 130 can include computing resources (hardware and software) available at a remote location and accessible over a network (for example, the Internet). In various embodiments, the cloud-based computing resources 130 are shared by multiple users and can be dynamically re-allocated based on demand. The cloud-based computing resources 130 include one or more server farms/clusters, including a collection of computer servers which can be co-located with network switches and/or routers. In various embodiments, the mobile device 110 can be connected to the computing cloud 130 via one or more wired or wireless communications networks 140.

In various embodiments, the mobile device 110 includes microphone(s) (e.g., transducers) 120 configured to receive voice input/acoustic sound from a user 150. The voice input/acoustic sound can be contaminated by a noise 160. Noise sources can include street noise, ambient noise, speech from entities other than an intended speaker(s), and the like.

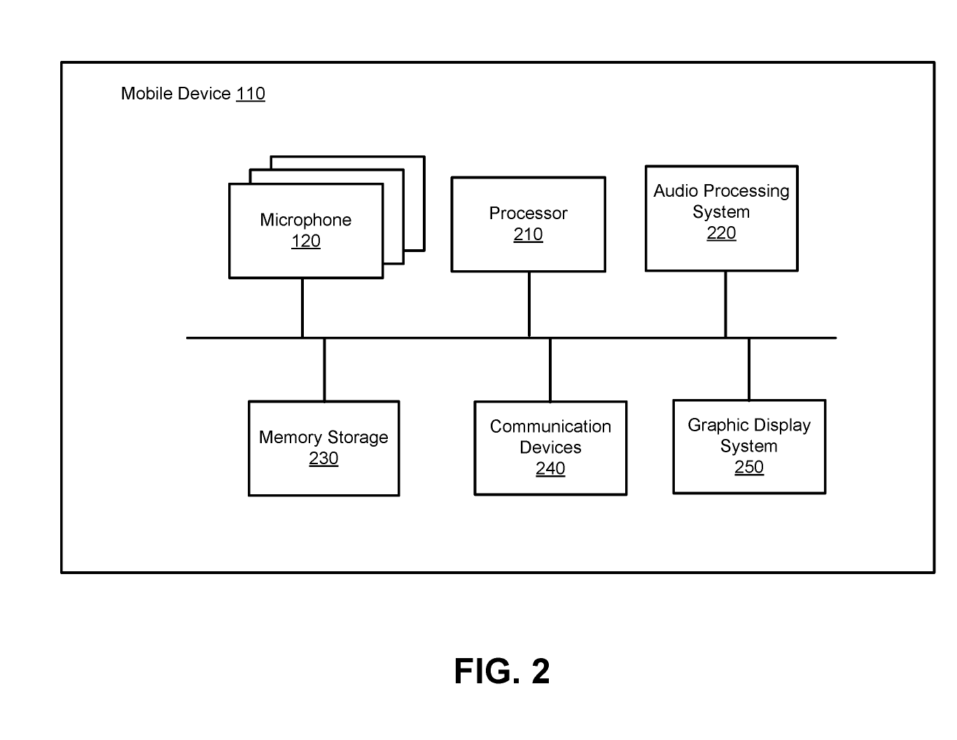

FIG. 2 is a block diagram illustrating components of the mobile device 110, according to various example embodiments. In the illustrated embodiment, the mobile device 110 includes one or more microphones 120, a processor 210, audio processing system 220, a memory storage 230, one or more communication devices 240, and a graphic display system 250. In certain embodiments, the mobile device 110 also includes additional or other components needed for operations of mobile device 110. In other embodiments, the mobile device 110 includes fewer components that perform similar or equivalent functions to those described with reference to FIG. 2.

In various embodiments, where the microphones 120 include multiple closely spaced omnidirectional microphones (e.g., 1-2 cm apart), a beam-forming technique can be used to simulate forward-facing and backward-facing directional microphone responses. In some embodiments, a level difference is obtained using the simulated forward-facing and the backward-facing directional microphone. The level difference can be used to discriminate speech and noise in, for example, the time-frequency domain, which can be further used in noise and/or echo reduction. In certain embodiments, some microphones 120 are used mainly to detect speech, and other microphones 120 are used mainly to detect noise. In yet further embodiments, some microphones 120 are used to detect both noise and speech.

In various embodiments, the acoustic signals, once received, for example, captured by microphone(s) 120, are converted into electric signals, which, in turn, are converted, by the audio processing system 220, into digital signals for processing in accordance with some embodiments. In some embodiments, the processed signals are transmitted for further processing to the processor 210.

Audio processing system 220 can be operable to process an audio signal. In some embodiments, the acoustic signal is captured by the microphone 120. In certain embodiments, acoustic signals detected by the microphone(s) 120 are used by audio processing system 220 to separate desired speech (for example, keywords) from the noise, thereby providing more robust ASR. Noise reduction may include noise cancellation and/or noise suppression. By way of example and not limitation, noise reduction methods are described in U.S. patent application Ser. No. 12/215,980, entitled “System and Method for Providing Noise Suppression Utilizing Null Processing Noise Subtraction,” filed Jun. 30, 2008, and in U.S. patent application Ser. No. 11/699,732, entitled “System and Method for Utilizing Omni-Directional Microphones for Speech Enhancement,” filed Jan. 29, 2007, which are incorporated herein by reference in their entireties.

The processor 210 may include hardware and/or software operable to execute computer programs stored in the memory storage 230. The processor 210 can use floating point operations, complex operations, and other operations, including providing a dynamic local ASR vocabulary, keyword detection, and hierarchical assignment of recognition tasks. In some embodiments, the processor 210 of the mobile device 110 includes, for example, at least one of a digital signal processor, image processor, audio processor, general-purpose processor, and the like.

The example mobile device 110 is operable, in various embodiments, to communicate over one or more wired or wireless communications networks 140 (as shown in FIG. 1), for example, via communication devices 240. In some embodiments, the mobile device 110 sends at least audio signal (speech) over a wired or wireless communications network 140. In certain embodiments, the mobile device 110 encapsulates and/or encodes the at least one digital signal for transmission over a wireless network (e.g., a cellular network).

The digital signal can be encapsulated over Internet Protocol Suite (TCP/IP) and/or User Datagram Protocol (UDP). The wired and/or wireless communications networks 140 (shown in FIG. 1) can be circuit switched and/or packet switched. In various embodiments, the wired communications network(s) 140 provide communication and data exchange between computer systems, software applications, and users, and include any number of network adapters, repeaters, hubs, switches, bridges, routers, and firewalls. The wireless communications network(s) 140 can include any number of wireless access points, base stations, repeaters, and the like. The wired and/or wireless communications networks 140 may conform to an industry standard(s), be proprietary, or combinations thereof. Various other suitable wired and/or wireless communications networks 140, other protocols, and combinations thereof can be used.

The graphic display system 250 can be configured at least to provide a graphic user interface. In some embodiments, a touch screen associated with the graphic display system 250 is utilized to receive input from a user. Options can be provided to a user via an icon or text buttons once the user touches the screen. In various embodiments of the disclosure, the graphic display system 250 can be used for providing a user actionable content and generating a dynamic local ASR vocabulary.

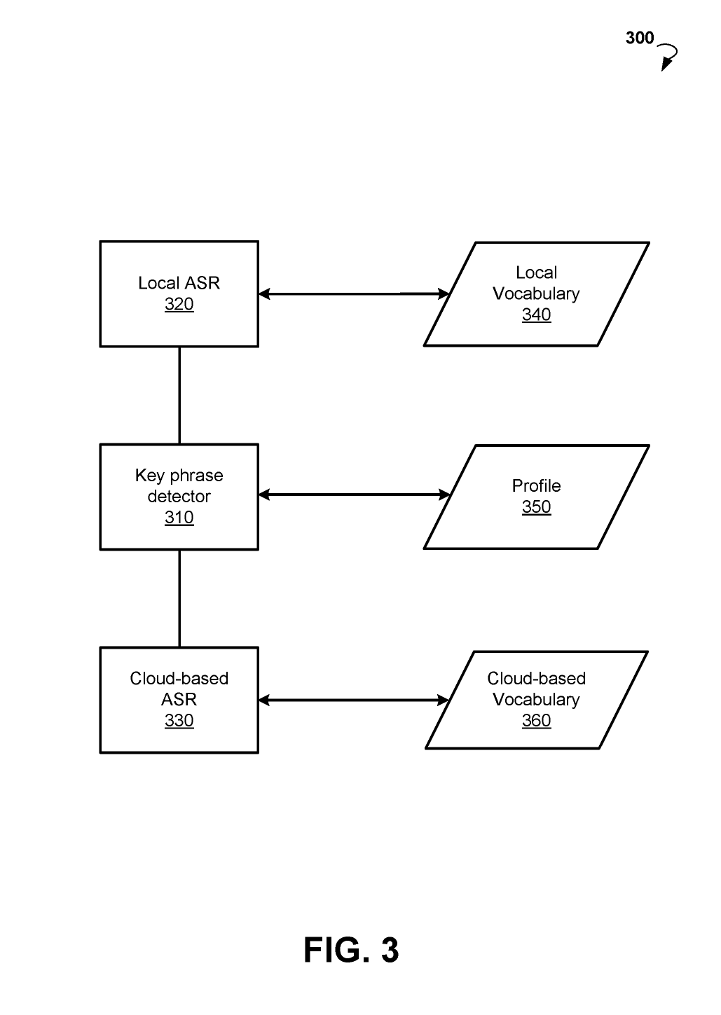

FIG. 3 is a block diagram showing a system 300 for providing a dynamic local ASR vocabulary and hierarchical assignment of recognition tasks, according an example embodiment. The example system 300 may include a key phrase detector 310, a local ASR module 320, and a cloud-based ASR module 330. In various embodiments, the modules 310-330 can be implemented as executable instructions stored either locally in memory of the mobile device 110 or in computing cloud 130.

The key phrase detector 310 may recognize the presence of one or more keywords in an acoustic audio signal, the acoustic audio signal representing at least one sound captured, for example, by microphones 120 of the mobile device 110. The term key phrase as used herein may comprise one or more key words. In some embodiments, the key phrase detector 310 can determine whether the one or more keywords represent one or more commands that can be performed locally on a mobile device, one or more commands that can be performed in the computing cloud, or one or more commands that can be performed locally and in the computing cloud. In various embodiments, the determination is based on a profile 350. The profile 350 can include user specific settings and/or mobile device specific settings and rules for processing acoustic audio signal(s). Based on the determination, the acoustic audio signal can be sent to local ASR 320 or cloud-based ASR 330.

In some embodiments, the local ASR module 320 can be associated with a dynamic local ASR vocabulary. In some embodiments, the cloud-based ASR 330 is based on the cloud-based vocabulary 360. In some embodiments, the cloud-based vocabulary 360 includes more entries than the dynamic local ASR vocabulary 340.

In some embodiments, when speech received from user 150 includes a recognized local command or key phrase, the key phrase including one or more keywords, the command can be performed locally (e.g., on a mobile device 110).

By way of example and not limitation, in response to the voice command “Call Eugene” being uttered, a key phrase detector 310 determines that “Call” is a local key phrase and then uses the local ASR engine 320 (also referred to herein as local recognizer) to recognize the rest of the command (“Eugene” in this example). In this example, a record (e.g., information for a “contact” including a telephone number) or other identifier associated with a name spoken after the “Call” command is retrieved locally on the mobile device 110 (not in the cloud-based computing resource(s) 130), and a call operation is initiated locally using the record. Other content stored locally (e.g., on the mobile device 110), such as that corresponding to commands associated with contact information (e.g., Call, Text, Email), audio or video content (e.g., Play), applications or bookmarked webpages (Open), or Locations (Find, Navigate) cab include commands initiated and/or performed locally.

Some embodiments include deciding (for example, by the key phrase detector 310) that commands are to be performed using a cloud-based computing resource(s) 130, instead of locally (e.g., on the mobile device 110), based on the command key phrase, or based upon the recognition of a likelihood of a match of models and observed extracted audio parameters. For example, when the speech received from a user corresponds to a voice command identified as a command for execution using the cloud-based computing resource(s) 130 (e.g., since it cannot be handled locally on the mobile device), a decision can be made to have the speech and/or recognized text forwarded to the cloud-based computing resources 130 for the ASR. Furthermore, for speech received from a user that includes a command recognized by the ASR as a command for execution by the cloud-based computing resource(s) 130, the command can be selected or designated for execution by the cloud-based computing resource(s) 130.

For example, in response to the voice command “find the address of a local Italian restaurant” being uttered, the key phrase “find the address” of the voice command is identified locally by the ASR. Based on the key phrase, the voice command (e.g., audio and/or recognized text) may be sent to the cloud-based computing resource 130 for the ASR and for execution of a recognized voice command by the cloud-based computing resource 130.

By way of example and not limitation, some commands can use processor resources, for example, context awareness obtained from a sensor hub or a geographic locator, such as a GPS, beacon, Bluetooth Low Energy (“BLE”), or WiFi, and store information more efficiently when delivered via cloud-based computing resources 130 than when performed locally.

Some embodiments can allow initiating of execution of and/or performing commands using both or different combinations of local resources (e.g., processor resources provided by and information stored on a mobile device) and cloud-based computing resource(s) 130 (e.g., processor resources provided by and information stored in the cloud-based computing resource(s) 130), depending upon the command. With regards to initiating execution of and/or performing commands, it should be appreciated that execution of some commands, e.g., “call”, is initiated by the mobile device 110 and can utilize various other components in order to fully execute the transmission of the call to a recipient who receives the call. It should be appreciated, therefore, that execution or executing, as referred to herein, refer to executing all or parts of the steps required to fully perform certain operations.

Some embodiments can allow determining at least one or more commands that can be performed locally, one or more commands that can be performed by a cloud-based computing resource(s), and one or more commands that can be performed using a combination of local resources and a cloud-based computing resource(s). In various embodiments, the determination is based, for example, at least on specifications and/or characteristics of the mobile device 110. In some embodiments, the determination is based, for example, in part on the characteristics or preferences of a user 150 of the mobile device 110.

Some embodiments include a profile 350, which may be associated with a certain mobile device 110 (e.g., a make and model) and/or the user 150. The profile 350, can indicate, for example, at least one of one or more commands that may be performed locally, one or more commands that can be performed by cloud-based computing resources 130, and one or more commands that may be performed using a combination of local resources and a cloud-based computing resource(s) 130. Various embodiments include a plurality of profiles, each profile being associated with a different (e.g., a make and model) mobile device and/or a different user. Some embodiments can include a default profile, which may be used when information concerning the mobile device and/or user is not available. The default profile can be used to set, for example, performance of all commands using cloud-based computer resources 130 or commands known to be efficiently delivered locally (for example, via minimal usage of local processing and information storage resources).

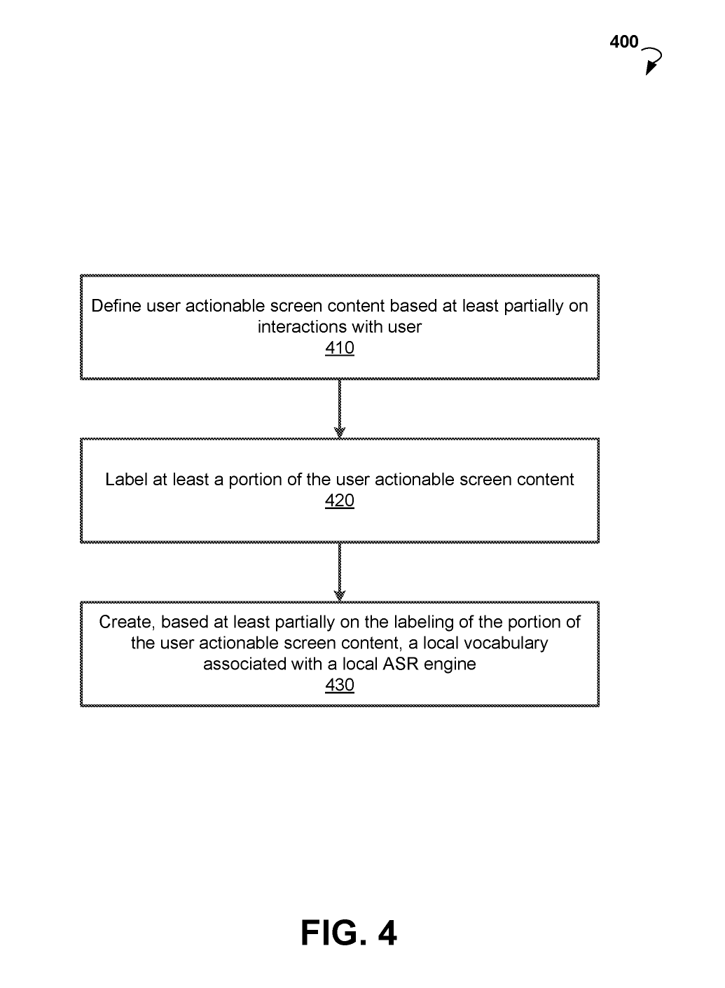

FIG. 4 is a flow chart illustrating a method 400 for providing a dynamic local ASR vocabulary, according to an example embodiment. In block 410, a user actionable screen content can be defined. The user actionable screen content can be at least partially based on user interactions. In some embodiments, the user actionable screen content is associated with a mobile device.

In block 420, at least a portion of the user actionable screen content can be labeled. In block 430, a local vocabulary can be generated based on the labeling. The local vocabulary can be associated with a local ASR engine. In certain embodiments, the local ASR engine is associated with the mobile device. In some embodiments, the local vocabulary includes words associated with certain functions of the mobile device. The local vocabulary can be limited by resources of the mobile device (such as memory and processor speed). In various embodiments, the local ASR engine and the local vocabulary are used to recognize one or more key phrases in a speech, for example, in audio signal captured by one or more microphones of the mobile device. In some embodiments, noise suppression or noise reduction is performed on the speech prior to performing the local ASR.

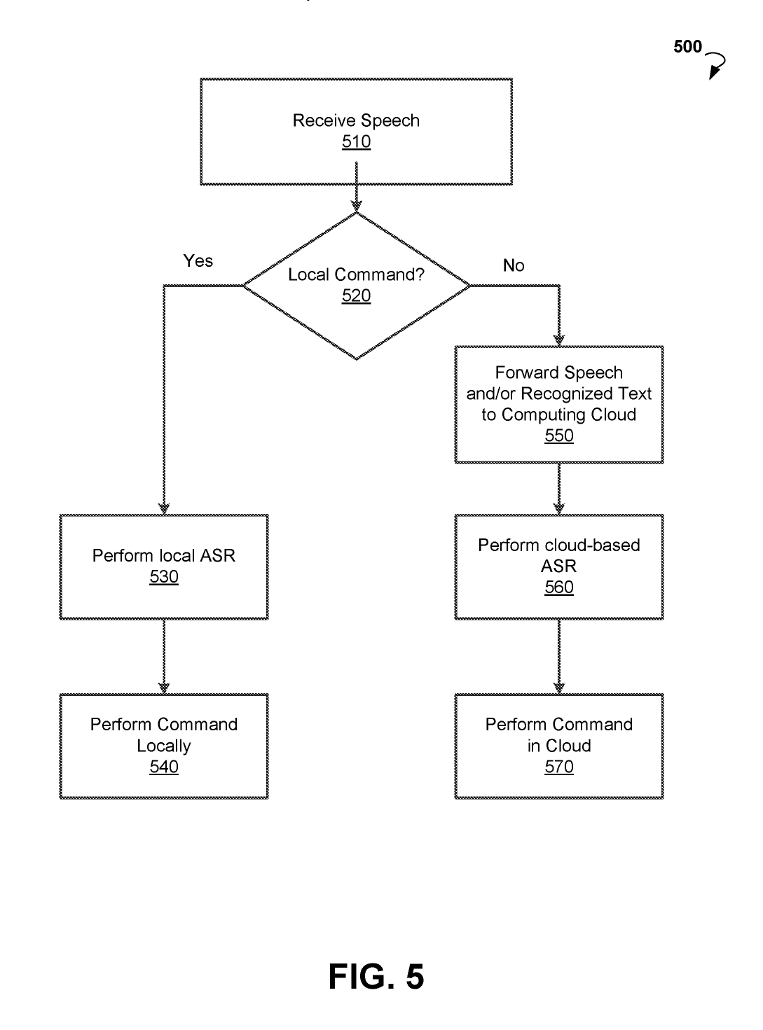

FIG. 5 is flow chart illustrating a method 500 for hierarchical assignment of recognition tasks, according to various embodiments. In block 510, speech (audio) may be received by the mobile device. For example, the user may speak, and the mobile device may sense/detect the speech through at least one transducer such as a microphone.

In decision block 520, based on the received speech, the device can detect whether the speech (audio) includes a voice command. In various embodiments, this detection is performed using a module that includes a key phrase detector (e.g., a local recognizer/engine).

In some embodiments, a determination is also made as to whether the “full” voice command can be executed locally. The “full” command refers to a key phrase comprising a command, plus additional speech (for example, “call Eugene”, where the key phrase is “call” and the full command is “call Eugene”). In some embodiments, the module both recognizes the “full” command and makes the determination as to whether the full command can be executed locally. The module can be operable to determine whether the received speech, and/or recognized text, includes at least one of a local key phrase or trigger (for example, recognize a key phrase which is associated with a voice command that can be executed locally), and/or a cloud key phrase or trigger (for example, recognize a keyword, text, or key phrase which may not be executed locally), and which may be (associated with) a voice command for which execution on a cloud-based computing resource(s) is required. In various embodiments, audio and/or recognized text is forwarded to the cloud.

Various embodiments can allow conserving system resources (for example, offer low power consumption, low processor overhead, low memory usage, and the like) by detecting the key phrase and determining whether local or cloud-based resources can handle the (full) voice command.

In block 530, based on a determination that the speech includes a voice command to be executed locally (e.g., one that can be executed locally), the mobile device performs the ASR on the speech, for example, using a local ASR engine to determine what the voice command is. In various embodiments, the local ASR engine uses a “small” vocabulary or dictionary (for example, a dynamic local ASR vocabulary). In some embodiments, the small vocabulary includes, for example, 1-100 words. In some embodiments, the number of words in this small “local” vocabulary can be more or less than in this example and less than the number available in a cloud-based resource having more memory storage. In various embodiments, the words in the small vocabulary include various commands used to interact with the mobile device's basic local functionality (e.g., unlock, dial, call, open application, schedule an appointment, and the like). In block 540, the voice command determined by the local ASR engine can be performed. In some embodiments, the cloud information can be used to provide instructions to the local engine. In various embodiments, the cloud can contain a calendar that is inaccessible by the local system, and, therefore, the local system is unable to determine a conflict in a schedule.

In block 550, based on the determination that the speech does not include a voice command to be executed locally (for example, one that cannot be executed locally), a determination is made that the mobile device is to forward the speech (audio) and/or recognized text to a cloud-based computing resource(s). This can be considered a decision (or selection) to forward to the cloud-based computing resource as opposed to a decision (or selection) to use local resources in the mobile device for execution (or at least to initiate execution for a command that requires other network resources such as a cellular network, for example). In some embodiments, a determination can be made to “select” use of various combinations of local and cloud-based resources for different commands.

In block 560, using the received speech, the cloud-based computing resource(s) can perform the ASR, for example, to determine or identify one or more voice commands. In some embodiments, the cloud-based ASR uses a “large” vocabulary. In certain embodiments, the large vocabulary includes over 100 words. The words in the large vocabulary can be used to process or decode complex sentences, which may approach natural language (for example, “tomorrow after work I would like to go to an Italian restaurant”). In various embodiments, the cloud-based ASR uses greater system resources than are practical and/or available on the mobile device (such as power consumption, processing power, memory, storage, and the like). In block 570, the one or more voice commands determined by the cloud-based ASR may be performed by the cloud-based computing resource(s).

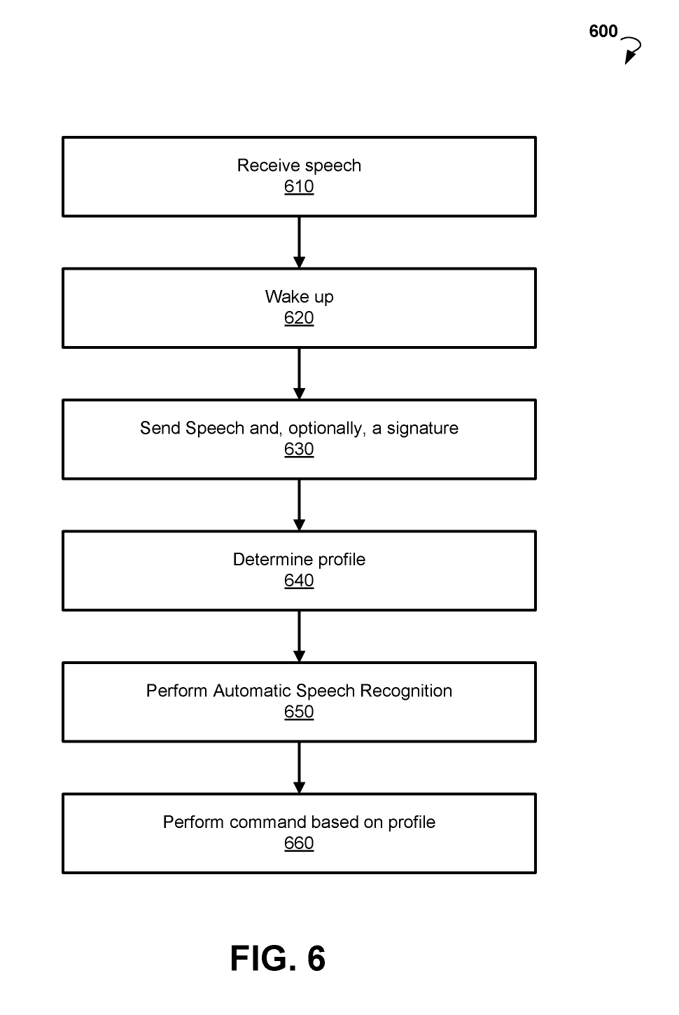

FIG. 6 is a flow chart illustrating a method 600 for selecting performance of speech recognition based on a profile, according to some embodiments. In block 610, speech (audio) is received by a mobile device. For example, the user can speak and the mobile device can sense/detect the speech through at least one transducer such as a microphone.

In block 620, in response to the received speech, the mobile device may “wake up.” For example, the mobile device can perform a transition from a lower-power consumption state of operation to a higher-power consumption state of operation, the transition optionally including one or more intermediate power consumption states of operation.

In various embodiments, in block 620, in one or more of the power consumption states, the mobile device determines that the speech includes at least a voice command (for example, using a key phrase detector).

In block 630, the mobile device can send the received speech and, optionally, a signature. In some embodiments, a signature includes an identifier associated with the mobile device and/or the user. For example, the signature can be associated with a certain make and model of a mobile device. By way of further example, the signature can be associated with a certain user. In some embodiments, the speech and, optionally, the signature are sent through wired and/or wireless communication network(s) to cloud-based computing resources.

In block 640, a profile can be determined. In some embodiments, the profile is determined based, optionally, upon a signature. The profile, for example, can indicate at least one of one or more commands that may be performed locally, one or more commands that may be performed by cloud-based computing resources, and one or more commands that may be performed using a combination of local resources and cloud-based computing resource(s). In some embodiments, the profile, for example, includes characteristics of the mobile device, such as capabilities of transducers (e.g., microphones), capabilities for processing noise and/or echo, and the like. In certain embodiments, the profile, for example, includes information specific to the user for performing the ASR. In some embodiments, a default profile is determined/used when, for example, a signature is not received or a profile is not otherwise available.

In block 650, the ASR is performed on the speech to determine a voice command. In some embodiments, optionally, the ASR is performed based on the determined profile. In some embodiments, the speech is processed (e.g., noise reduction/suppression/cancelation, echo cancelation, and the like) prior to performing the ASR. In certain embodiments, the ASR is performed by a cloud-based computing resource(s).

At block 660, the determined voice command can be performed locally, by a cloud-based computing resource(s), or combination of the two, based at least on the received profile. For example, the command can be performed solely or more efficiently locally, by the cloud-based computing resource(s), or by a combination of the two, and a determination as to where to perform the command can be made based on these or like criteria. In some embodiments, a decision can be made to perform certain commands always locally even if such commands may be performed by the cloud-based computing resource(s) or by a combination of the two. In some embodiments, a determination can be made to always first perform certain commands locally and, if a local ASR score is low (e.g., a mismatch between speech and the local vocabulary), perform the commands remotely using the cloud-based computing resource(s).

Thus, the flow charts of FIGS. 4-6 illustrate the functionality/operations of various implementations of systems, methods, and computer program products according to embodiments of the present technology. It should be noted that, in some alternative embodiments, the functions noted in the blocks may occur out of the order noted in FIGS. 4-6, or omitted altogether. For example, two blocks shown in succession may, in fact, be performed substantially concurrently, or the blocks may sometimes be performed in the reverse order.

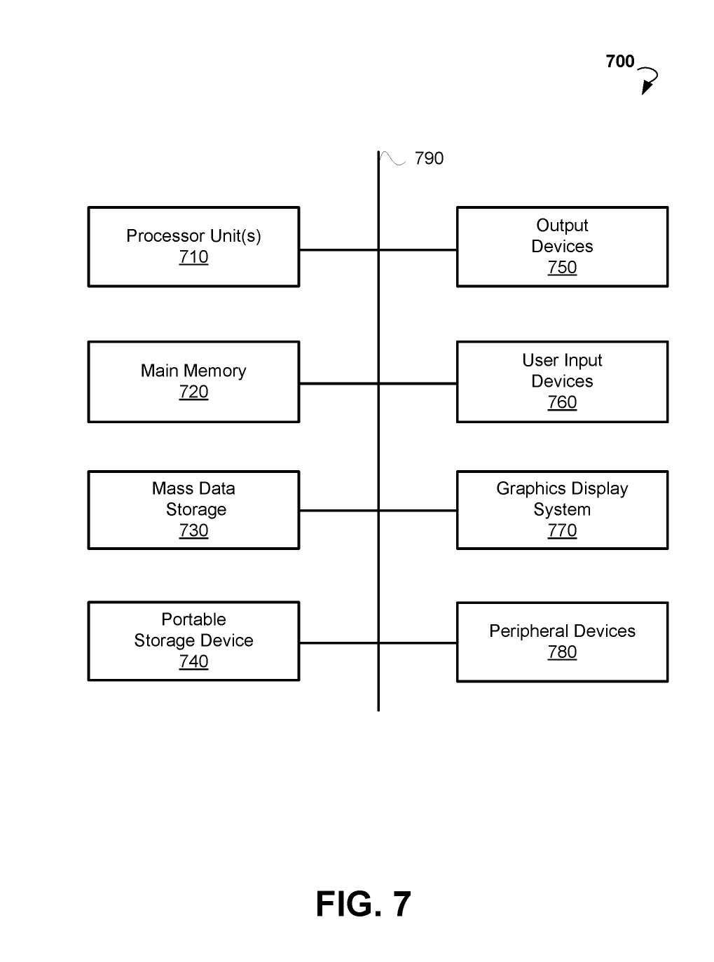

FIG. 7 illustrates an exemplary computer system 700 that may be used to implement some embodiments of the present invention. The computer system 700 of FIG. 7 may be implemented in the contexts of the likes of computing systems, networks, servers, or combinations thereof. The computer system 700 of FIG. 7 includes one or more processor units 710 and main memory 720. Main memory 720 stores, in part, instructions and data for execution by processor units 710. Main memory 720 stores the executable code when in operation, in this example. The computer system 700 of FIG. 7 further includes a mass data storage 730, portable storage device 740, output devices 750, user input devices 760, a graphics display system 770, and peripheral devices 780.

The components shown in FIG. 7 are depicted as being connected via a single bus 790. The components may be connected through one or more data transport means. Processor unit 710 and main memory 720 is connected via a local microprocessor bus, and the mass data storage 730, peripheral device(s) 780, portable storage device 740, and graphics display system 770 are connected via one or more input/output (I/O) buses.

Mass data storage 730, which can be implemented with a magnetic disk drive, solid state drive, or an optical disk drive, is a non-volatile storage device for storing data and instructions for use by processor unit 710. Mass data storage 730 stores the system software for implementing embodiments of the present disclosure for purposes of loading that software into main memory 720.

Portable storage device 740 operates in conjunction with a portable non-volatile storage medium, such as a flash drive, floppy disk, compact disk, digital video disc, or Universal Serial Bus (USB) storage device, to input and output data and code to and from the computer system 700 of FIG. 7. The system software for implementing embodiments of the present disclosure is stored on such a portable medium and input to the computer system 700 via the portable storage device 740.

User input devices 760 can provide a portion of a user interface. User input devices 760 may include one or more microphones, an alphanumeric keypad, such as a keyboard, for inputting alphanumeric and other information, or a pointing device, such as a mouse, a trackball, stylus, or cursor direction keys. User input devices 760 can also include a touchscreen. Additionally, the computer system 700 as shown in FIG. 7 includes output devices 750. Suitable output devices 750 include speakers, printers, network interfaces, and monitors.

Graphics display system 770 include a liquid crystal display (LCD) or other suitable display device. Graphics display system 770 is configurable to receive textual and graphical information and processes the information for output to the display device.

Peripheral devices 780 may include any type of computer support device to add additional functionality to the computer system.

The components provided in the computer system 700 of FIG. 7 are those typically found in computer systems that may be suitable for use with embodiments of the present disclosure and are intended to represent a broad category of such computer components that are well known in the art. Thus, the computer system 700 of FIG. 7 can be a personal computer (PC), handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 700 is implemented as a cloud-based computing environment, such as a virtual machine operating within a computing cloud. In other embodiments, the computer system 700 may itself include a cloud-based computing environment, where the functionalities of the computer system 700 are executed in a distributed fashion. Thus, the computer system 700, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computer system 700, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for providing a dynamic local automatic speech recognition (ASR) vocabulary, the method comprising:
defining a user actionable screen content associated with a mobile device;
labeling at least a portion of the user actionable screen content; and
creating, based at least partially on the labeling, a first vocabulary, the first vocabulary being associated with a first ASR engine.

2. The method of claim 1, wherein the user actionable screen content is based at least partially on user interactions with the mobile device.

3. The method of claim 1, wherein the first ASR engine is associated with the mobile device.

4. The method of claim 1, wherein the first vocabulary includes words associated with at least one function of the mobile device.

5. The method of claim 1, wherein a size of the first vocabulary depends on resources of the mobile device.

6. The method of claim 1, further comprising:
detecting at least one key phrase in speech, the speech including at least one captured sound;
determining whether the at least one key phrase is a local key phrase or a cloud-based key phrase;
if the at least one key phrase is a local key phrase, performing the ASR on the speech with the first ASR engine; and
if the at least one key phrase is a cloud-based key phrase:
forwarding at least one of the speech and the at least one key phrase to at least one cloud-based computing resource; and
performing the ASR on the speech with a second ASR engine associated with a second vocabulary, the second ASR engine being associated with the at least one cloud-based computing resource.

7. The method of claim 6, further comprising performing at least one of noise suppression and noise reduction on the speech before performing the ASR on the speech by the first ASR engine to improve robustness of the ASR.

8. The method of claim 6, wherein the first vocabulary is smaller than the second vocabulary.

9. The method of claim 6, wherein the first vocabulary includes from 1 to 100 words and the second vocabulary includes more than 100 words.

10. The method of claim 6, wherein the determination as to whether the at least one key phrase is a local key phrase or a cloud-based key phrase is based at least partially on a profile, the profile being associated with one of the mobile device or the user and including at least one of the following:
commands to be executed locally on the mobile device;
commands to be executed remotely in the cloud;
commands to be executed both locally on the mobile device and remotely in the cloud; and
at least one rule, the at least one rule including at least:
forwarding the speech to the cloud to perform the ASR on the speech by the second ASR engine if a score of performing the ASR on the speech by the first ASR engine is less than a pre-determined value.

11. A system for providing a dynamic local automatic speech recognition (ASR) vocabulary, the system comprising:
at least one processor; and
a memory communicatively coupled with the at least one processor, the memory storing instructions which, when executed by the at least one processor, performs a method comprising:
defining a user actionable screen content associated with a mobile device;
labeling at least a portion of the user actionable screen content; and
creating, based at least partially on the labeling, a first vocabulary, the first vocabulary being associated with a first ASR engine.

12. The system of claim 11, wherein the user actionable screen content is based at least partially on user interactions with the mobile device.

13. The system of claim 11, wherein the first ASR engine is associated with the mobile device.

14. The system of claim 11, wherein the first vocabulary includes words associated with at least one function of the mobile device.

15. The system of claim 11, wherein a size of the first vocabulary is limited by resources of the mobile device.

16. The system of claim 11, further comprising:
detecting at least one key phrase in speech, the speech including at least one captured sound;
determining whether the at least one key phrase is a local key phrase or a cloud-based key phrase;
if the at least one key phrase is a local key phrase, performing the ASR on the speech with the first ASR engine; and
if the at least one key phrase is a cloud-based key phrase:
forwarding at least one of the speech and the at least one key phrase to at least one cloud-based computing resource; and
performing ASR on the speech with a second ASR engine associated with a second vocabulary, the second ASR engine being associated with the cloud.

17. The system of claim 16, further comprising performing at least one of noise suppression and noise reduction on the speech before performing the ASR on the speech by the first ASR engine to improve robustness of the ASR.

18. The system of claim 16, wherein the first vocabulary includes from 1 to 100 words and the second vocabulary includes more than 100 words.

19. The system of claim 16, wherein the determination as to whether the at least one key phrase is a local key phrase or a cloud-based key phrase is based at least partially on a profile, the profile being associated with one of the mobile device or the user and including one or more of the following:
commands to be executed locally on the mobile device;
commands to be executed remotely in the cloud;
commands to be executed both locally on the mobile device and remotely in the cloud; and
at least one rule, the at least one rule including at least:
forwarding the speech to the cloud to perform the ASR on the speech by the second ASR engine if a score of performing the ASR on the speech by the first ASR engine is less than a pre-determined value.

20. A non-transitory computer-readable storage medium having embodied thereon instructions, which, when executed by at least one processor, perform steps of a method, the method comprising:
defining a user actionable screen content associated with a mobile device, the user actionable screen content being based at least partially on user interactions with the mobile device;
labeling at least a portion of the user actionable screen content; and
creating, based at least partially on the labeling, a first vocabulary, the first vocabulary being associated with a first ASR engine.
